(19) United States
(12) Patent Application Publication
(10) Pub. No.: US 2006/0144404 A1
(43) Pub. Date: Jul. 6, 2006

(54) Respiratory mask

(76) Inventor: Eoin J.P. Callan, Douglassville, PA (US)

Correspondence Address: GARDNER GROFF SANTOS & GREENWALD, P.C., 2018 POWERS FERRY ROAD, SUITE 800, ATLANTA, GA, 30339, US

(21) Appl. No.: 11/365,160

(22) Filed: Mar. 1, 2006

Related U.S. Application Data
(62) Division of application No. 10/706,521, filed on Nov. 12, 2003.

(51) Int. Cl. A62B 23/02; A62B 18/02

(52) U.S. Cl. 128/206.19; 128/206.12; 128/206.28

(57) ABSTRACT

A respiratory mask with a display of graphics and/or text visible on a surface thereof. The display may provide an incentive for people to wear the mask, aid in the identification of the person wearing the mask, or reduce intimidation of children at the doctor's office, among other advantages. The invention is also relates to a method of advertising and/or conveying information by including a display on a respiratory mask.

### TECHNICAL FIELD

The present invention relates generally to protective garments and procedures, and more particularly to respiratory masks having graphical and/or informational displays. The invention also relates to a method of advertising and/or conveying information by way of displaying graphics and/or information on a respiratory mask.

### BACKGROUND OF THE INVENTION

Respiratory masks are commonly worn to prevent the spread of contagious infectious diseases. Generally, natural or synthetic fibers are tightly woven into panels or formed into non-woven panels. The panels typically have micropores sized to allow the passage of air, but prevent the passage of infectious viruses, bacteria, dust, and pollen. Medical practitioners wear the masks to prevent cross-contamination when treating different patients. Patients with autoimmune deficiencies wear the masks to prevent contraction of deadly infections. As respiratory diseases increase in virulence, healthy people are increasingly inclined to wear the masks for protection as evidenced by the recent deadly Sudden Acute Respiratory Syndrome (SARS) outbreak.

To be effective, respiratory masks must be consistently worn when infectious agents are present. Because many medical practitioners, patients, and everyday people find the masks aesthetically displeasing, they are not always worn when they should be. Additionally, the masks are usually not visually distinctive, sometimes requiring removal for identification. Along these lines, it can be quite frightening for a child to visit the doctor's office, only to see an unfamiliar person in a mask covering their face approach. It has been discovered by the applicant that it may be far less threatening for a child if medical practitioners were to wear a decorative respiratory mask displaying a friendly cartoon character or something familiar or entertaining to the child.

Thus it can be seen that needs exist for improvements to respiratory and surgical masks to provide an incentive for users to consistently wear the masks when in the presence of infectious agents. Needs further exist for providing an outlet for people to decrease apprehension, express their personality and to ease identification while wearing surgical masks. Still further needs exist for marketing and advertising methods displaying graphics, text, and/or information on a surgical mask.

### SUMMARY OF THE INVENTION

In example forms, the present invention is a respiratory mask having one or more graphical or informational displays applied to an exterior surface thereof. In example embodiments, the mask comprises graphics and/or text displayed on an outer front surface of the mask.

In one aspect, the invention is a respiratory mask having one or more graphical features applied to the surface thereof, that aid in reducing anxiety experienced by children and others who may otherwise be intimidated by visiting the doctor's office.

In another aspect, the present invention is a respiratory mask having graphics and/or text displayed thereon, which portray the wearer's personality or a desired personal image.

In still another aspect, the invention is a respiratory mask having one or more displays which aid in the identification of the wearer.

In yet another aspect, the invention is a method for advertising and/or conveying information by displaying graphics and/or text on a respiratory mask.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a perspective view of a mask according to a first embodiment of the present invention;

FIG. 2 is a front view of the mask of FIG. 1;

FIG. 3 is a back view of the mask of FIG. 1;

FIG. 4 is a perspective view of a mask according to a second embodiment of the present invention;

FIG. 5 is a is a front view of the mask of FIG. 4;

FIG. 6 is a rear end view of the mask of FIG. 4;

FIG. 7 is a perspective view of a mask according to a third embodiment of the present invention;

FIG. 8 is a front view of the mask of FIG. 7;

FIG. 9 is a back view of the mask of FIG. 7;

FIG. 10 is a perspective view of the mask according to a fourth embodiment of the present invention;

FIG. 11 is a front view of the mask of FIG. 10;

FIG. 12 is a back view of the mask of FIG. 10.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

With reference now to the drawing figures, a respiratory mask 10 is shown and described by way of example embodiments of the present invention. The respiratory mask 10 preferably comprises a tightly woven or non-woven natural or synthetic fiber panel 12 having a first side 14 and a second side 16. One or more displays 18, such as graphical and/or textual material are provided on the first or outer side 14 of the mask 10. Alternatively or additionally, the display(s) 18 may be placed on the second or inner side 16 of the panel 12 if the fabric is sufficiently transparent, or if the graphics will “bleed” through the panel 12 and become visible when viewed from the outer side 14.

In use, the inner side 16 of the panel is held against the maxilla facial region of the user's face with the aid of one or more fasteners 20. In the depicted example embodiments, the fasteners 20 comprise a plurality of laces or straps that are tied or otherwise connected behind the user's head. However, the proper positioning of the respiratory mask 10 can be accomplished by way of any suitable releasable coupling member or element, such as for example, snap fittings, adhesive bands, hook-and-loop fasteners, elastics, ratcheting tie mechanisms, or the like.

The depicted example embodiments comprise displays 18 including graphical and/or informational features applied to a surface of a flexible mask 10, which conforms to the user's face when worn; however further embodiments of the invention include similar or like displays 18 applied onto preformed surgical masks. Examples of such preformed masks include for example, the 8210 N95 Particulate Respirator, commercially available from 3M Manufacturing, St. Paul, Minn. The type of mask and amount of fiber in the panels 12 will depend on the user's desired protection and comfort level. It will be understood that respiratory masks according to the present invention are also worn for reasons beyond the prevention of infection. For example, activities that produce high concentrations of particulate matter such as dust and mold include woodworking, yard work, and the like. The present invention encompasses displays including graphics and/or text on respirators of the types used under these conditions, as well as others.

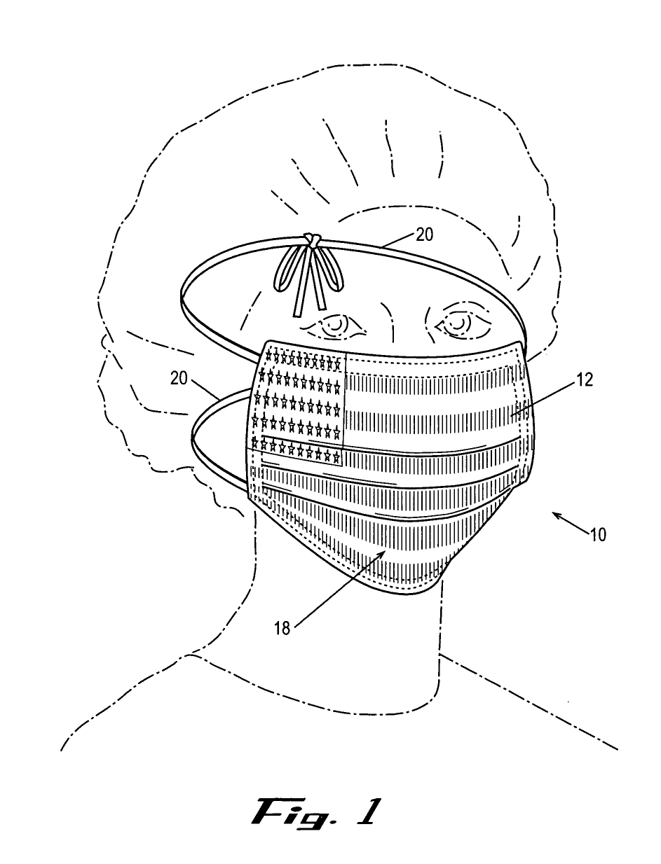

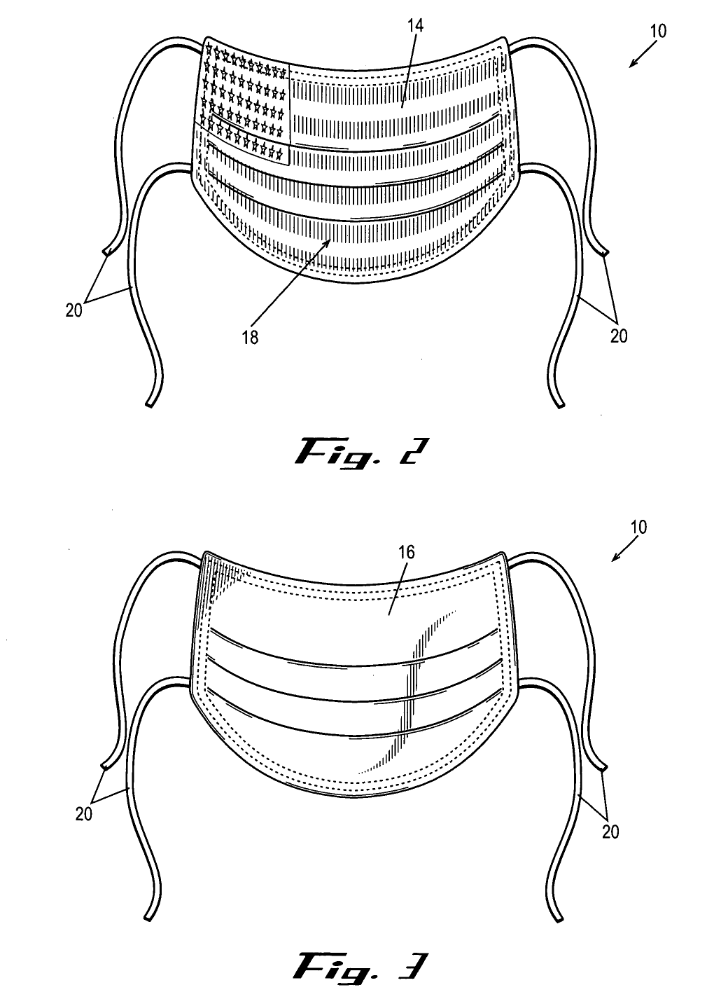

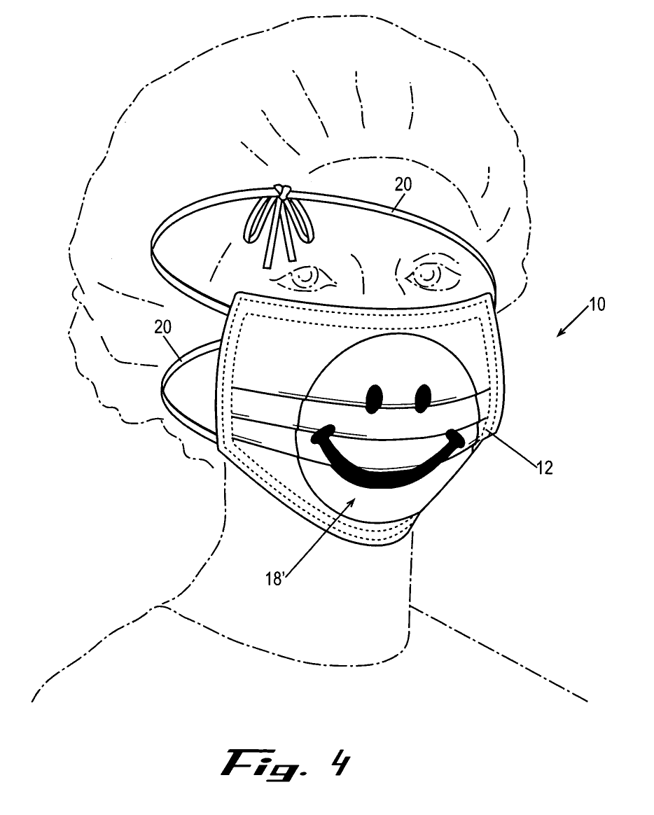

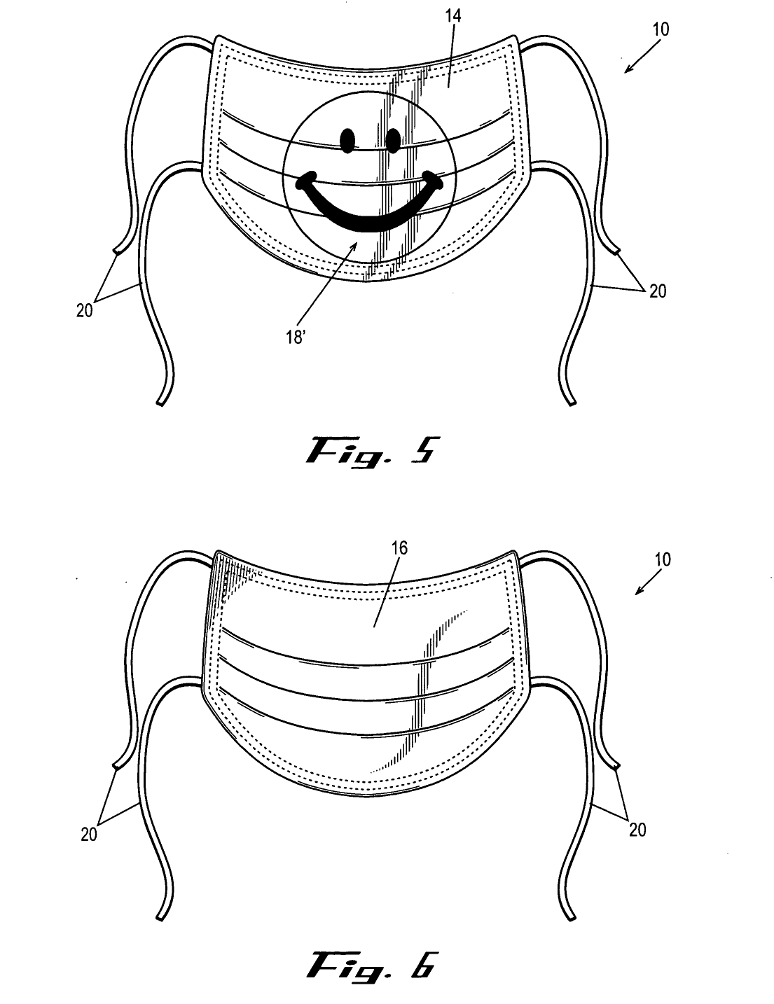

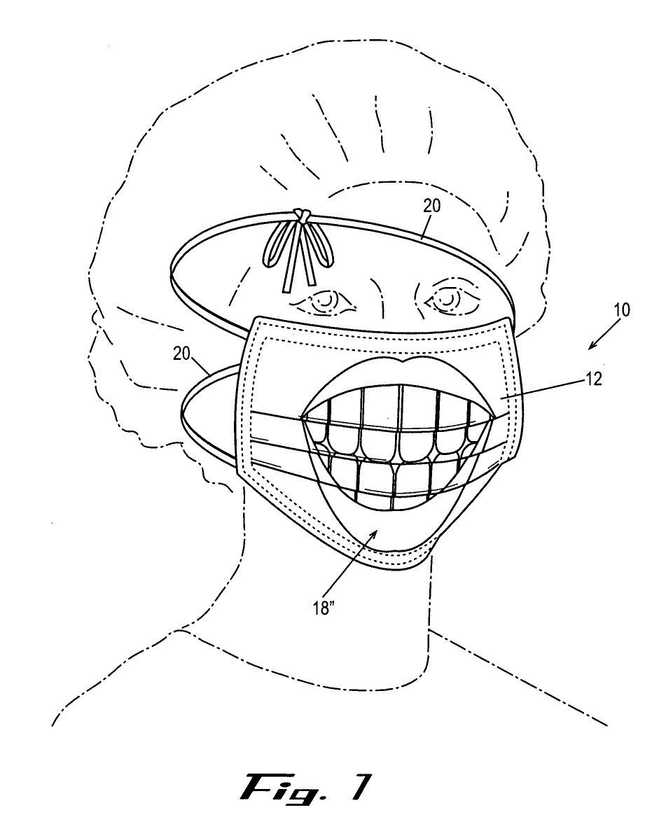

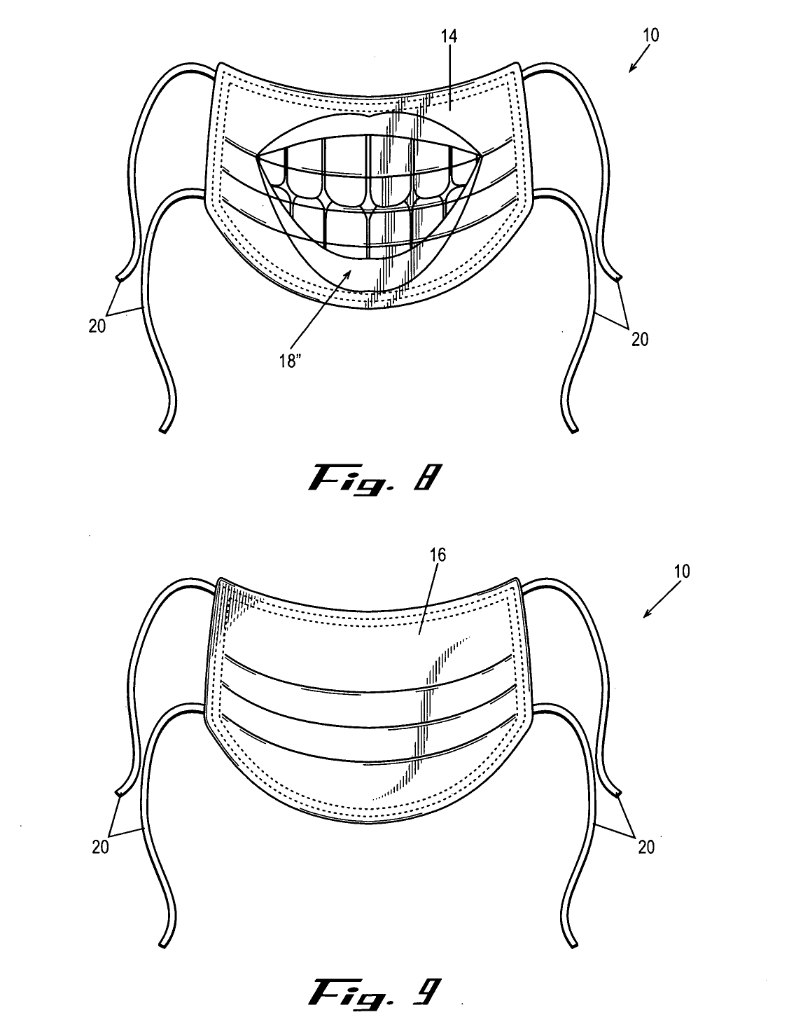

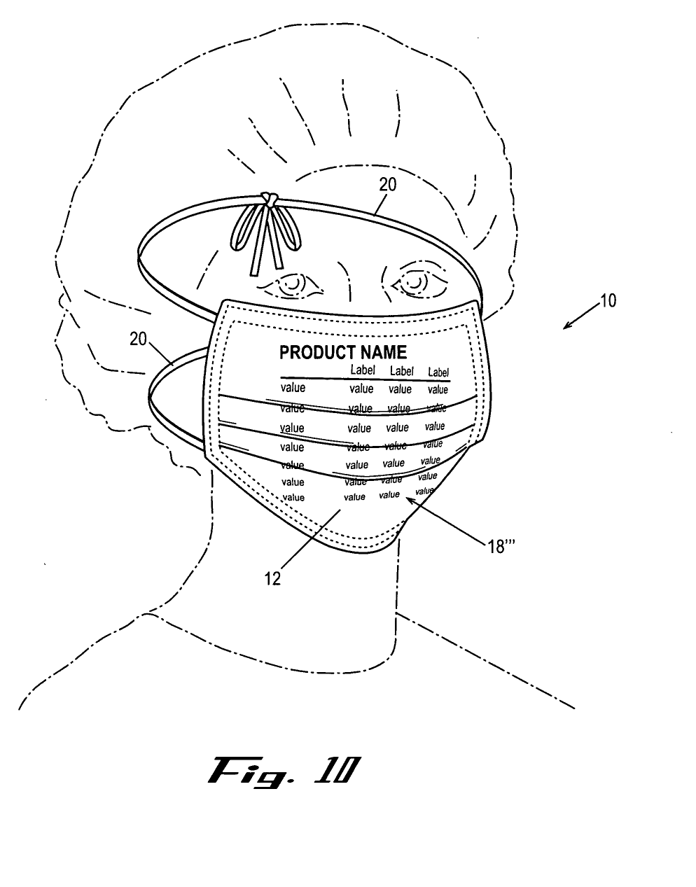

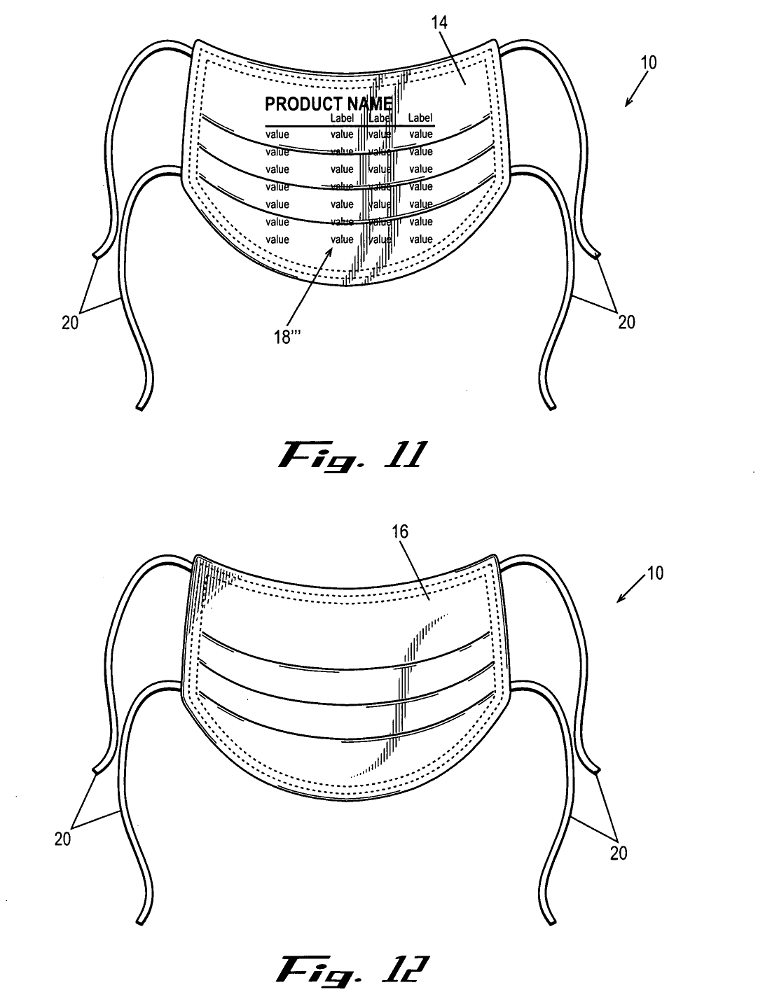

The example embodiments show only a few of the many displays that may be included on the surface of a respiratory mask according to the present invention. For example, FIGS. 1-3 show a display comprising the image of an American flag on the outer surface of the mask. Displays comprising images of flags, symbols, or icons of any nation, group, or organization on the mask surface are also within the scope of the present invention. Additionally, displays comprising logos or slogans of companies or affiliations are also within the scope of the invention; as well as pictures or information depicting or relating to celebrities, cartoon characters, politicians, or athletes.

Displays comprising such depictions of popular icons or other graphical or text material may be used in conjunction with an advertising campaign utilizing an advertising method according to the present invention. In example embodiments, the advertising method of the present invention comprises including information regarding a product or service offering of an advertiser on the display of a respiratory mask as described herein. For example, if the masks are designed to be worn by medical practitioners, the images may target pharmaceutical or health-related products such as drugs, medical devices, hospitals or other car groups, and/or insurance programs. If the health-care professional is a pediatrician, the mask could have displays advertising products and services for children, such as snack foods, childrens' television programs, toys, games and/or the like. In alternative embodiments, the masks could inform the patient of their government-mandated rights when receiving healthcare. Likewise, if an advertising campaign targets lawn care professionals, the masks may comprise displays including graphics and/or information regarding pesticides, fertilizer, and other lawn care related information and material. Similarly, a mask marketed toward those individuals around sawdust may comprise a display including information and material regarding woodworking tools, finishes, supply stores and the like. The advertising method of the present invention optionally further comprises giving the masks to representative professionals in fields related to the advertised offering for free or at a discount, and/or offering encouragement or incentives to representative professionals for wearing, distributing, displaying, purchasing and/or otherwise utilizing said masks.

Graphical and informational displays may also be used to identify a person or a group of people having specified characteristics. For example, in a highly infectious disease outbreak location, the masks could comprise displays including information regarding symptoms or diagnoses to assist the triaging of patients. Such a mask and method could inform the medical practitioner of the patient's symptoms or condition without removing the patient's mask to speak. Alternatively, the mask could comprise a display identifying the treatment a patient is undergoing. In other embodiments, the mask of the present invention comprises a display identifying the medical specialties or roles of a medical professional wearer.

The graphical or informational displays 18 can be applied to the mask by dying, printing, heat transfer or sublimation, embroidery, or any suitable application method. If the mask is pleated, the graphics can be applied to have the intended dimensions when expanded during wearing. In an alternative embodiment, the graphical or informational display changes appearance as the mask expands. For example, the display may have the appearance of a closed mouth when the pleats are folded, and change to the appearance of a smiling mouth when expanded.

While the invention has been described with reference to preferred and example embodiments, it will be understood by those skilled in the art that a variety of modifications, additions and deletions are within the scope of the invention, as defined by the following claims.

1-11. (canceled)

12. An advertising method comprising:
providing a respiratory mask comprising at least one visible display; and
including information regarding an offering of an advertiser in the at least one visible display of the respiratory mask.

13. The advertising method of claim 12, further comprising giving the mask to a representative professional in a field related to the advertised offering for free or at a discount.

14. The advertising method of claim 12, further comprising offering an incentive to a representative professional for utilizing the mask.

15. The method of claim 12, wherein the step of including information regarding an offering of an advertiser in the at least one visible display of the respiratory mask comprises displaying information regarding a pharmaceutical product on the mask.

16. The method of claim 12, wherein the step of including information regarding an offering of an advertiser in the at least one visible display of the respiratory mask comprises displaying information regarding a lawn-care product on the mask.

17. The method of claim 12, wherein the step of including information regarding an offering of an advertiser in the at least one visible display of the respiratory mask comprises displaying information regarding a woodworking product on the mask.

18. The method of claim 12, wherein the step of including information regarding an offering of an advertiser in the at least one visible display of the respiratory mask comprises displaying information regarding children's products or services on the mask.

19. The method of claim 12, wherein the step of including information regarding an offering of an advertiser in the at least one visible display of the respiratory mask comprises displaying information regarding television programming on the mask.

20. The method of claim 12, wherein the step of including information regarding an offering of an advertiser in the at least one visible display of the respiratory mask comprises displaying information regarding a consumer product on the mask.

21. A method of conveying information to at least one person, said method comprising providing an informational message, visible by the at least one person, on a respiratory mask.

22. The method of claim 21, wherein the informational message is an advertisement.

23. The method of claim 22, wherein the advertisement advertises a healthcare offering, and wherein said method further comprises providing said respiratory mask to a healthcare professional.

24. The method of claim 23, further comprising providing at least one incentive to the healthcare professional to use the respiratory mask.

25. The method of claim 24, wherein the at least one incentive provided to the healthcare professional comprises providing the respiratory mask to the healthcare professional for free or at a discounted cost.

26. The method of claim 22, wherein the advertisement is targeted to children, and wherein said method further comprises providing said respiratory mask to a pediatrician.

27. The method of claim 22, wherein the advertisement is directed to a lawn care related offering.

28. The method of claim 22, wherein the advertisement is directed to a woodworking related offering.

29. The method of claim 21, wherein the informational message comprises information about at least one healthcare regulation, and wherein said method further comprises providing said respiratory mask to a healthcare professional.

30. An advertising campaign for the healthcare field, said advertising campaign comprising:
providing a respiratory mask with an advertising message promoting a healthcare-related offering visible thereon;
making the respiratory mask available to a healthcare professional; and
offering an incentive to the healthcare professional to use the respiratory mask.
